(19) United States
(12) Patent Application Publication
(10) Pub. No.: US 2025/0346121 A1
(43) Pub. Date: Nov. 13, 2025

(54) INSTRUMENT PANEL OF VEHICLE

(71) Applicant: TOYOTA JIBOSHA KABUSHIKI KAISHA, Toyota-shi (JP)

(72) Inventors: Yusuke Yamamoto, Toyota-shi (JP); Ren Mayumi, Toyota-shi (JP); Akinori Yamaguchi, Toyota-shi (JP)

(73) Assignee: TOYOTA JIBOSHA KABUSHIKI KAISHA, Toyota-shi (JP)

(21) Appl. No.: 19/024,735

(22) Filed: Jan. 16, 2025

(30) Foreign Application Priority Data
May 8, 2024 (JP) 2024-075805

(51) Int. Cl. B60K 37/20; B60R 21/205

(52) U.S. Cl. CPC B60K 37/20; B60R 21/205; B60K 2360/688

(57) ABSTRACT

An airbag retainer for attaching the airbag main body and a tray disposed below the airbag retainer are attached to the panel main body of the instrument panel of the vehicle. The upper tray is attached to the panel main body by clips. The airbag retainer is formed with an opening portion through which the clip can be viewed.

### CROSS-REFERENCE TO RELATED APPLICATION

This application claims priority to Japanese Patent Application No. 2024-075805 filed on May 8, 2024, incorporated herein by reference in its entirety.

### BACKGROUND

### 1. Technical Field

The present disclosure relates to an instrument panel of a vehicle.

### 2. Description of Related Art

An instrument panel of a vehicle is an interior component positioned on a front side of vehicle front seats. More specifically, the instrument panel is an entire panel including various meters, switches for an air conditioning device, an audio device, an airbag for a front passenger seat, and the like. For example, an airbag, a tray, an air outlet of an air conditioning device, a glove box, and the like are disposed in the instrument panel on the side of the front passenger seat (Japanese Unexamined Patent Application Publication No. 2014-065451 (JP 2014-065451 A), for example).

An instrument panel 110 in the related art will be described using FIGS. 5 and 6. Note that an arrow FR, an arrow UP, and an arrow RH illustrated in each drawing indicate a forward direction (traveling direction), an upward direction, and a rightward direction of the vehicle, respectively.

In recent years, there is a trend that the length of the instrument panel 110 in the vehicle up-down direction is shortened (the width in the vehicle up-down direction is reduced) from the viewpoint of an improvement in visibility from the front seats of the vehicle. On the other hand, it is desirable to avoid reduction of a storage space of a tray 140 on the side of the front passenger seat. Thus, a configuration in which an air outlet 121 of an AC and the tray 140 are disposed to be aligned in the left-right direction (vehicle width direction) is adopted in the instrument panel 110 on the side of the front passenger seat as illustrated in FIG. 5, instead of a configuration in the related art in which the air outlet of the AC and the tray are disposed to be aligned in the up-down direction.

With the above configuration, it is possible to shorten the length of the instrument panel 110 in the vehicle up-down direction. On the other hand, it is necessary to increase the length of the tray 140 in the vehicle up-down direction in order to increase a storage space of the tray 140, and an airbag 130 and the tray 140 are thus closely situated.

Here, the airbag 130 is configured such that an airbag main body 131 is attached to an airbag retainer 132 attached to a panel main body 120 as illustrated in FIG. 6. The airbag retainer 132 is attached to the panel main body 120 through welding. On the other hand, the tray 140 is attached to the panel main body 120 with a clip 150 as a fastening tool.

Referring again to FIG. 6, a process of assembling the instrument panel 110 in the related art will be described.

In the process of assembling the instrument panel 110, the airbag 130 and the tray 140 are attached to the panel main body 120. Note that it is assumed that an operator performs the assembling from a rear side of the instrument panel 110. In the process of assembling the instrument panel 110, the airbag retainer 132 may be attached to the panel main body 120. In this case, a space for using a welding machine is needed, and the airbag retainer 132 is thus attached to the panel main body 120 before the tray 140.

Since the tray 140 is attached to the panel main body 120 with the airbag retainer 132 attached thereto, a space for attachment is narrow, and the tray 140 is thus split into an upper tray 141 and a lower tray 142. When the tray 140 is attached, the lower tray 142 is attached to the panel main body 120 with a bolt and the like first. Thereafter, the upper tray 141 is attached to the panel main body 120 and the lower tray 142. At this time, the upper tray 141 and the panel main body 120 are attached with a clip 150 as a fastening tool.

### SUMMARY

In the aforementioned process of assembling the instrument panel 110, the operator attaches the upper tray 141 to the panel main body 120 with the clip 150 from the rear side of the instrument panel 110. At this time, the clip 150 is hidden by the airbag retainer 132 attached before, and it is thus not possible to check whether the upper tray 141 has been securely fixed to the panel main body 120 with the clip 150.

Therefore, it is necessary for the operator to look into a narrow clearance in order to check whether the upper tray 141 has been securely fixed to the panel main body 120 with the clip 150, which leads to degradation of operation efficiency.

Thus, an object of the present disclosure is to provide an instrument panel capable of improving operation efficiency in a process of assembling the instrument panel.

An instrument panel of a vehicle according to the present disclosure includes: an airbag retainer that is for attachment of an airbag main body; and a tray that is disposed below the airbag retainer, the airbag retainer and the tray being attached to a panel main body, a part of the tray is attached to the panel main body with a fastening tool, and an opening portion through which the fastening tool is visually recognizable is formed in the airbag retainer.

According to the above configuration, it is possible to check from the opening portion whether the part of the tray is securely fixed to the panel main body with the fastening tool.

In the instrument panel of a vehicle according to the present disclosure, the airbag main body is preferably attached to the airbag retainer by being locked at the opening portion of the airbag retainer.

According to the above configuration, it is possible to check whether the part of the tray is securely fixed to the panel main body with the fastening tool using the opening portion of the airbag retainer at which the airbag main body is locked.

In the instrument panel of a vehicle according to the present disclosure, the tray is preferably disposed to be aligned with an air outlet of an air conditioning device in a vehicle width direction.

According to the above configuration, it is possible to shorten the length of the instrument panel in the vehicle up-down direction (to reduce the width in the vehicle up-down direction).

According to the instrument panel of a vehicle of the present disclosure, it is possible to improve operation efficiency in a process of assembling the instrument panel.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a front view illustrating a passenger seat side of an instrument panel that is an example of an embodiment;

FIG. 2 is a rear perspective view showing a passenger seat side of the instrument panel as an example of the embodiment;

FIG. 3 is a rear perspective view of an example airbag retainer and tray;

FIG. 4 is a front perspective view showing an airbag as an example of the embodiment;

FIG. 5 is a front view showing a passenger seat side of a conventional instrument panel; and

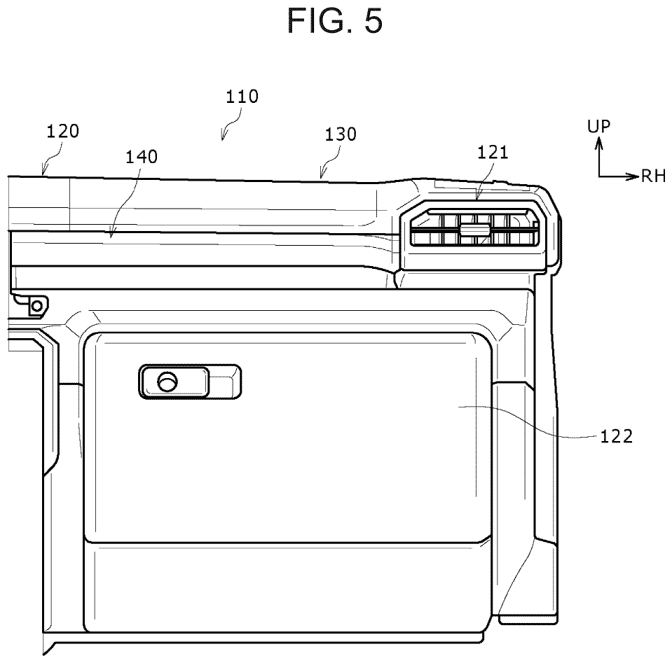

FIG. 6 is a rear perspective view showing a passenger seat side of a conventional instrument panel.

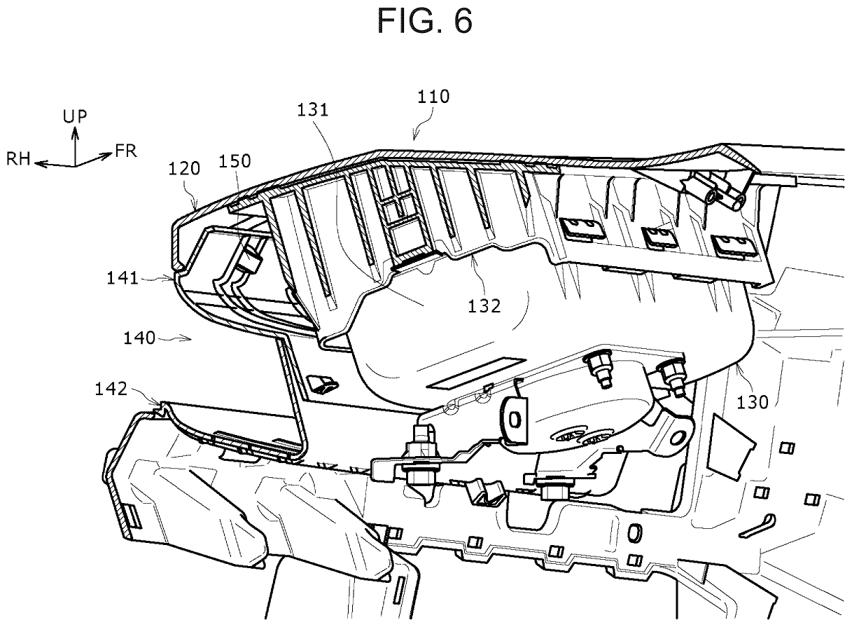

### DETAILED DESCRIPTION OF EMBODIMENTS

Hereinafter, an example of the embodiment of the present disclosure will be described in detail. In the following description, specific shapes, materials, directions, numerical values, and the like are examples for facilitating the understanding of the present disclosure, and can be appropriately changed according to applications, purposes, specifications, and the like.

### Instrument Panel

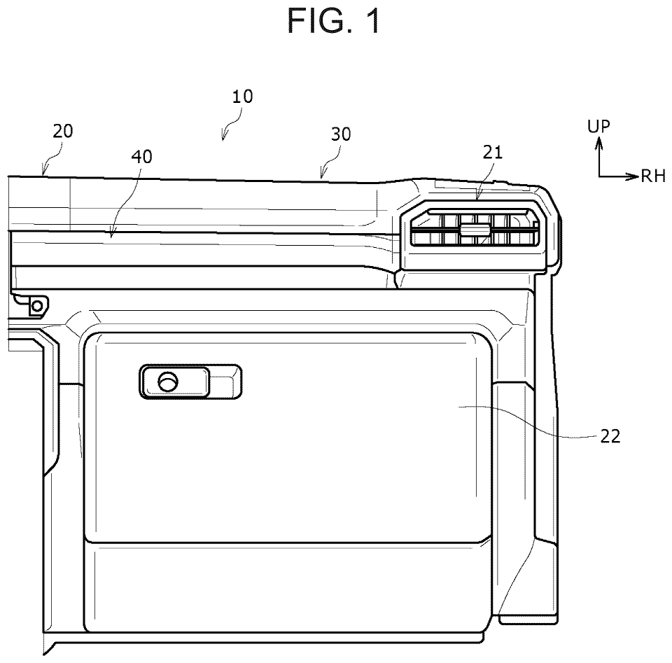

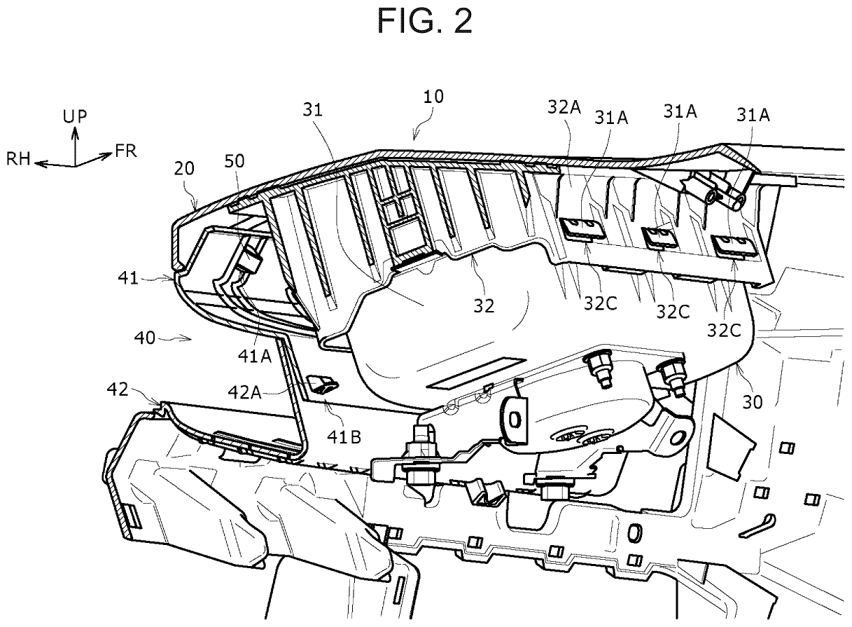

The instrument panel 10, which is an example of the embodiment, will be described with reference to FIGS. 1 and 2. FIG. 1 is a front view of the instrument panel 10 on the passenger seat side. FIG. 2 is a perspective view of the instrument panel 10 as viewed from the rear side of the passenger seat side.

Note that an arrow FR, an arrow UP, and an arrow RH illustrated in each drawing indicate a forward direction (traveling direction), an upward direction, and a rightward direction of the vehicle, respectively. The opposite directions of each arrow FR, UP, and RH indicate a rear direction, a downward direction, and a leftward direction of the vehicle, respectively. Hereinafter, when the description is made simply using terms indicating directions i.e., forward and rearward, right and left, and upward and downward, these means forward and rearward in the vehicle front-rear direction, right and left in the vehicle right-left direction (vehicle width direction), and upward and downward in the vehicle up-down direction unless otherwise specified. Further, in the present embodiment, the structure of the left steering wheel is described as an example, but the present disclosure is also applicable to the right steering wheel.

The instrument panel 10 is the entire interior portion located on the front side of the front seat of the vehicle. On the front passenger side of the instrument panel 10 (in the present embodiment, on the right side in the vehicle width direction), an airbag 30, a tray 40, an air conditioning device (not shown) for air-conditioning the vehicle cabin of the vehicle, an air outlet 21, a glove box 22, and the like, which will be described in detail later, are disposed in the panel main body 20.

On the front passenger seat side of the instrument panel 10, the air outlet 21 and the tray 40 of the air conditioning device are arranged side by side in the left-right direction (vehicle width direction). With such a configuration, compared to a configuration in which the air outlet and the tray of the conventional air conditioning device are arranged side by side in the vehicle vertical direction, the length of the instrument panel 10 in the vehicle vertical direction can be shortened (the width in the vehicle vertical direction can be reduced). Thus, the visibility of the front seat can be improved.

### Airbag

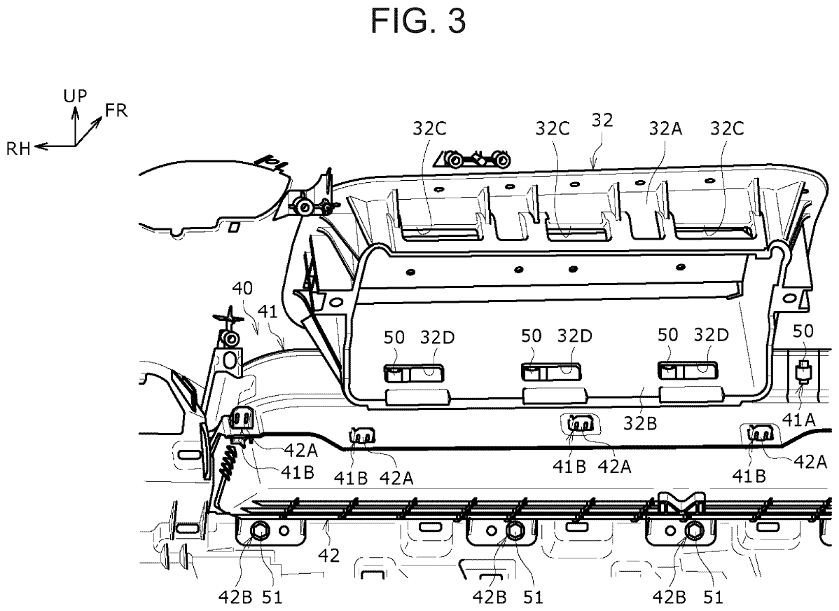

An airbag 30, which is an example of the embodiment, will be described with reference to FIGS. 2 to 3. FIG. 3 is a perspective view of the instrument panel 10 as viewed from the rear side of the passenger seat side.

The airbag 30 assists the action of the seat belt to reduce an impact of an occupant of the passenger seat when the passenger seat collides. The airbag 30 includes an airbag main body 31 in which a bag body is accommodated, and an airbag retainer 32 that supports the airbag main body 31 and is attached to the panel main body 20.

The airbag main body 31 has a plurality of claw portions 31A (three on the front side and three on the rear side in the present embodiment) on both sides in the front-rear direction. The airbag main body 31 is attached to the airbag retainer 32 by locking the claw portion 31A of the airbag main body 31 to the opening portion 32C, 32D of the airbag retainer 32.

The airbag retainer 32 is formed in a rectangular frame shape having a front wall 32A and a rear wall 32B. The airbag main body 31 is attached to the airbag retainer 32 so that the airbag main body 31 is fitted into the airbag retainer 32. A plurality of (three in the present embodiment) opening portions 32C are formed in the front wall 32A. A plurality of (three in the present embodiment) opening portions 32D are formed in the rear wall 32B. As described above, the airbag main body 31 is attached to the airbag retainer 32 by locking the claw portion 31A of the airbag main body 31 to the opening portion 32C, 32D of the airbag retainer 32.

Further, from the opening portion 32D of the rear wall 32B, the clip 50 as a fastening tool can be visually recognized from the rear surface of the instrument panel 10, which will be described later. Thus, in the assembling process of the instrument panel 10, it is possible to confirm whether or not the upper tray 41 is securely fixed to the panel main body 20 by the clip 50.

### Tray

Referring again to FIGS. 1 to 3, a tray 40 which is an example of an embodiment will be described.

The tray 40 is a storage space opened on the front side of the passenger seat. In the instrument panel 10 of the present embodiment, as described above, the air outlet 21 and the tray 40 are arranged side by side in the vehicle width direction, and in order to increase the storage space of the tray 40, the length of the tray 40 in the vehicle vertical direction is formed so as to be longer. The tray 40 is divided in the vehicle up-down direction and includes an upper tray 41 and a lower tray 42.

The upper tray 41 forms an upper portion of the tray 40. A plurality of opening portions 41A are formed in the upper end portion of the upper tray 41. A plurality of opening portions 41B are formed in the lower end portion of the upper tray 41. The upper tray 41 is attached to the lower tray 42 by locking the claw portion 42A of the lower tray 42, which will be described later, to the opening portion 41B of the upper tray 41. On the other hand, the upper tray 41 is attached to the panel main body 20 by inserting the clip 50 as a fastening tool into the opening portion (not shown) of the panel main body 20 and the opening portion 41A of the upper tray 41.

The lower tray 42 forms a lower portion of the tray 40. A plurality of claw portions 42A are formed at the upper end portion of the lower tray 42 along the vehicle-width direction. At the lower end of the lower tray 42, a plurality of opening portions 42B are formed along the vehicle widthwise. As described above, the upper tray 41 is attached to the lower tray 42 by locking the claw portion 42A of the lower tray 42 to the opening portion 41B of the upper tray 41. On the other hand, the lower tray 42 is attached to the panel main body 20 by inserting the bolt 51 into the opening portion 42B of the lower tray 42 and fastening it to the panel main body 20.

### Assembly Process of the Instrument Panel

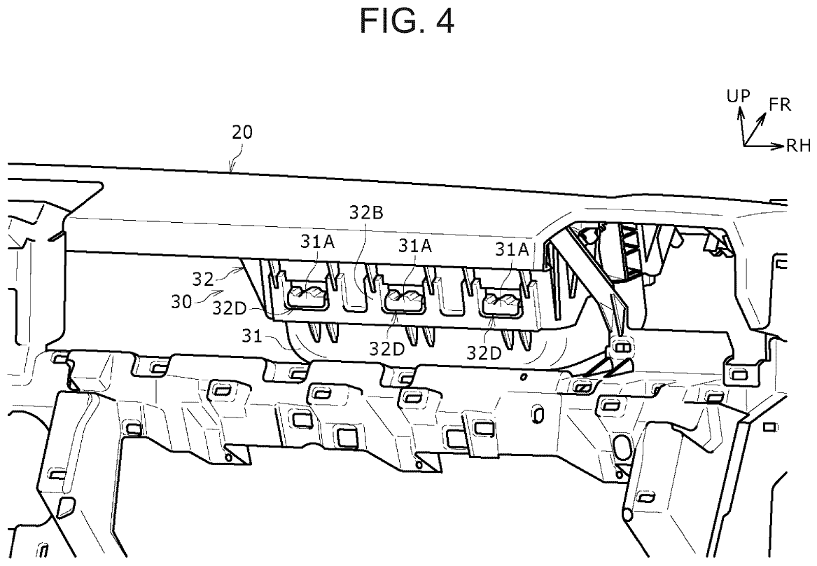

The assembling process of the instrument panel 10 will be described with reference to FIGS. 2 to 4. Incidentally, FIG. 4 is a perspective view from the front side, not shown, other than the panel main body 20 and the airbag 30 in the passenger side of the instrument panel 10.

In the assembling process of the instrument panel 10, the airbag 30 and the tray 40 are attached to the panel main body 20. It is assumed that the operator assembles the instrument panel 10 from the rear side. First, the airbag retainer 32 is welded to the panel main body 20 by a welding machine. At this time, since no other component (such as the tray 40) is attached to the panel main body 20, a sufficient space for using the welding machine is secured.

Next, the lower tray 42 is fastened to the panel main body 20 by the bolts 51. Next, the clip 50 is inserted into the panel main body 20. Next, the opening portion 41A of the upper tray 41 is locked to the clip 50 inserted into the panel main body 20, the opening portion 41B of the upper tray 41 is locked to the claw portion 42A of the lower tray 42, and the upper tray 41 is attached to the panel main body 20 and the lower tray 42.

In the present embodiment, the panel main body 20 and the upper tray 41 are fixed by using the clip 50 as a fastening tool, but the present disclosure is not limited thereto. For example, an opening portion formed in the upper tray may be locked to a claw formed in the panel main body.

The opening portion 41A of the upper tray 41 may be locked to the clip 50 inserted into the panel main body 20. Here, although the clip 50 is hidden by the rear wall 32B of the airbag retainer 32, the opening portion 32D of the rear wall 32B can confirm whether the upper tray 41 is securely fixed to the panel main body 20 by the clip 50 (whether the clip 50 is securely inserted into the opening portion 41A of the upper tray 41). Accordingly, the workability of the assembling process of the instrument panel 10 can be improved.

It should be noted that the present disclosure is not limited to the above-described embodiments and modifications thereof, and it goes without saying that various changes and improvements can be made within the scope of the matters described in the claims of the present application.

What is claimed is:

1. An instrument panel of a vehicle, the instrument panel comprising:
an airbag retainer that is for attachment of an airbag main body; and
a tray that is disposed below the airbag retainer, the airbag retainer and the tray being attached to a panel main body, wherein
a part of the tray is attached to the panel main body with a fastening tool, and
an opening portion through which the fastening tool is visually recognizable is formed in the airbag retainer.

2. The instrument panel according to claim 1, wherein the airbag main body is attached to the airbag retainer by being locked at the opening portion of the airbag retainer.

3. The instrument panel according to claim 1, wherein the tray is disposed to be aligned with an air outlet of an air conditioning device in a vehicle width direction.
